(19) United States
(12) Patent Application Publication
(10) Pub. No.: US 2021/0058766 A1
(43) Pub. Date: Feb. 25, 2021

(54) METHODS, SYSTEMS, AND COMPUTER READABLE MEDIA FOR GROUP DEVICE TRIGGERING FOR INTERNET OF THINGS (IoT) DEVICES

(71) Applicant: Oracle International Corporation, Redwood Shores, CA (US)

(72) Inventors: Venkatesh Aravamudhan, Bangalore (IN); Anup Shivarajapura, Bangalore (IN); Nitin Gupta, Bangalore (IN)

(21) Appl. No.: 16/546,227

(22) Filed: Aug. 20, 2019

(51) Int. Cl. H04W 8/18; H04W 4/14; H04W 48/16; H04W 8/04; H04W 8/08; H04W 76/11

(52) U.S. Cl. CPC H04W 8/186; H04W 4/14; H04W 76/11; H04W 8/04; H04W 8/08; H04W 48/16

(57) ABSTRACT

A method for group device triggering for IoT devices includes receiving, from a requesting node, a device trigger request message. The method further includes determining that the device trigger request message requests group IoT device triggering. The method further includes, in response to determining that the device trigger request message requests group IoT device triggering, resolving an external group identifier in the device trigger request message to individual international mobile station identifiers (IMSIs) corresponding to target IoT devices of the device trigger request message. The method further includes signaling a downstream node to trigger the target IoT devices.

### TECHNICAL FIELD

The subject matter described herein relates to triggering IoT devices. More particularly, the subject matter described herein relates to methods, systems, and computer readable media for group device triggering for IoT devices.

### BACKGROUND

In Third Generation Partnership Project (3GPP) defined networks, IoT devices can be sensors or other devices that provide information to the network in response to a trigger request. In some situations, it may be desirable to trigger a group of IoT devices to respond at the same time. Current 3GPP specifications do not define a procedure for group triggering of IoT devices. Instead, the network must contact each IoT device required to be triggered using an internet protocol (IP) address for that device, and the device will respond to the trigger request message.

One use case for triggering IoT devices occurs when the service capability server/application server (SCS/AS) wants the IoT device to send mobile originated data via the SGi interface. However, the IP address of the IoT device is not known to the SCS/AS. This may be because the IoT device did not register with the network or because the IoT device attaches to the network without a packet data network (PDN) connection and does not yet have an IP address.

Another scenario in which it may be desirable to trigger a group of IoT devices is when the service capability exposure function (SCEF) wants the user equipment (UE) to initiate a non-IP PDN connection so that the SCEF can send to the (IoT device) UE non-IP mobile terminated data received from the SCS/AS. In either of these scenarios, the UE cannot be contacted because the IP address of the UE is not known, and there is no defined group device trigger procedure. Accordingly, there exists a need for methods, systems, and computer readable media for group device triggering for IoT devices.

### SUMMARY

Methods, systems, and computer readable media for group device triggering for IoT devices are disclosed. The steps described herein allow an SCS or AS to initiate triggering of a group of IoT devices using a single device trigger request message including an external group identifier for triggering a group of IoT devices. The node that receives the device trigger request and resolves the external group identifier into a list of IMSIs can be a network exposure function/service capability exposure function (NEF/SCEF) or an SMSC. As used herein, the term “NEF/SCEF” is intended to refer to a node that is configured to perform NEF functions, SCEF functions, or a combination of NEF and SCEF functions.

One method for group device triggering for IoT devices includes receiving, from a requesting node, a device trigger request message. The method further includes determining that the device trigger request message requests group IoT device triggering. The method further includes, in response to determining that the device trigger request message requests group IoT device triggering, resolving an external group identifier in the device trigger request message to individual international mobile station identifiers (IMSIs) corresponding to target IoT devices of the device trigger request message. The method further includes signaling a downstream node to trigger the target IoT devices.

According to another aspect of the subject matter described herein, the method of claim 1 wherein the requesting node comprises an application server (AS) and receiving the device trigger request message includes receiving a single device trigger message from the AS including the external group identifier for triggering the target IoT devices.

According to yet another aspect of the subject matter described herein, the requesting node comprises a service capability server (SCS) and the device trigger request message comprises a single device trigger request message including the external group identifier for triggering the target IoT devices.

According to yet another aspect of the subject matter described herein, the external group identifier is associated with a group of IoT devices of the same type.

According to yet another aspect of the subject matter described herein, the external group identifier is associated with a group of IoT devices in the same geographic area.

According to yet another aspect of the subject matter described herein, the device trigger message is received at a network exposure function/service capability exposure function (NEF/SCEF) and resolving the external group identifier into the IMSIs includes querying, by the NEF/SCEF, a home subscriber server (HSS) using the external group identifier.

According to yet another aspect of the subject matter described herein, querying the HSS using the external group identifier includes sending a subscriber information request (SIR) command to the HSS and including the external group identifier in an attribute value pair of the SIR command.

According to yet another aspect of the subject matter described herein, signaling a downstream node to trigger the IoT devices in the group includes sending, from the NEF/SCEF, for each of the IMSIs, a device trigger request message to a short message service center (SMSC).

According to yet another aspect of the subject matter described herein, receiving the device trigger request message includes receiving the device trigger request message at a short message service center (SMSC) and wherein resolving the external group identifier into the IMSIs includes querying, by the SMSC a home subscriber server (HSS) using the external group identifier.

According to yet another aspect of the subject matter described herein, signaling a downstream node includes sending, for each of the IMSIs, a forward short message (FSM) message from the SMSC to a mobility management entity (MME) serving an IoT device corresponding to the IMSI.

According to yet another aspect of the subject matter described herein, a system for group device triggering for Internet of things (IoT) devices is provided. The system includes a group IoT device triggering node including at least one processor. The system further includes an IoT device triggering manager implemented by the at least one processor for receiving, from a requesting node, a device trigger request message, determining that the device trigger request message requests group IoT device triggering, and, in response to determining that the device trigger request message requests group IoT device triggering, resolving an external group identifier in the device trigger request message to individual international mobile station identifiers (IMSIs) corresponding to target IoT devices of the device trigger request message, and signaling a downstream node to trigger the target IoT devices.

According to yet another aspect of the subject matter described herein, the requesting node comprises an application server (AS) and wherein the IoT device triggering manager is configured to receive a single device trigger message from the AS including the external group identifier for triggering the target IoT devices.

According to yet another aspect of the subject matter described herein, the requesting node comprises a service capability server (SCS) and the IoT device triggering manager is configured to receive a single device trigger request message including the external group identifier for triggering the target IoT devices.

According to yet another aspect of the subject matter described herein, the group IoT device triggering node comprises a network exposure function/service capability exposure function (NEF/SCEF) and resolving the external group identifier into the IMSIs includes querying, by the NEF/SCEF, a home subscriber server (HSS) using the external group identifier. The system of claim 16 wherein the IoT device trigger manager is configured to send, from the NEF/SCEF, for each of the IMSIs, a device trigger request message to a short message service center (SMSC).

According to yet another aspect of the subject matter described herein, the group IoT device triggering node comprises a short message service center (SMSC) and resolving the external group identifier into the IMSIs includes querying, by the SMSC a home subscriber server (HSS) using the external group identifier.

According to yet another aspect of the subject matter described herein, the IoT device trigger manager is configured to send, for each of the IMSIs, a forward short message (FSM) message from the SMSC to a mobility management entity (MME) serving an IoT device corresponding to the IMSI.

According to yet another aspect of the subject matter described herein, a non-transitory computer readable medium having stored thereon executable instructions that when executed by the processor of a computer control the computer to perform steps is provided. The steps include receiving, from a requesting node, a device trigger request message. The steps further include determining that the device trigger request message requests group IoT device triggering. The steps further include, in response to determining that the device trigger request message requests group IoT device triggering, resolving an external group identifier in the device trigger request message to individual international mobile station identifiers (IMSIs) corresponding to target IoT devices of the device trigger request message. The steps further include signaling a downstream node to trigger the target IoT devices.

The subject matter described herein can be implemented in software in combination with hardware and/or firmware. For example, the subject matter described herein can be implemented in software executed by a processor. In one exemplary implementation, the subject matter described herein can be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

The subject matter described herein will now be explained with reference to the accompanying drawings of which:

FIG. 1 is a network diagram illustrating exemplary network components for communicating with IoT devices;

FIG. 2A is a call flow diagram illustrating exemplary messaging for group triggering of IoT devices;

FIG. 2B is an alternate call flow diagram illustrating exemplary messaging for group triggering of IoT devices;

FIG. 3 is a block diagram illustrating an exemplary group device triggering node for group triggering of IoT devices; and

FIG. 4 is a flow chart illustrating an exemplary process for group triggering of IoT devices.

### DETAILED DESCRIPTION

As stated above, 3GPP specifications do not currently define a procedure for simultaneously triggering a group of IoT devices. Instead, individual IoT devices are contacted using their IP addresses, which may not be known to the AS that desires to send a message to the IoT devices. The subject matter described herein includes a group device triggering procedure intended to efficiently trigger a group of devices together. The devices may be of the same type, e.g., sensors, or may belong to the same geographic location. In one example, to implement the group device triggering procedure, an AS sending a device trigger message to a network exposure function/service capability exposure function (NEF/SCEF) may include a parameter in the message referred to as an external group identifier. The NEF/SCEF receives the device trigger request and resolves the external-group-identifier into a list of external identifiers, which is stored by the NEF/SCEF. The NEF/SCEF executes the device trigger procedure for each of the external identifiers. The NEF/SCEF sends a single device trigger response to the SCS/AS. The NEF/SCEF may then trigger the IoT devices using 3GPP defined triggering procedures. In an alternate example, a short message service center (SMSC) resolves the external group identifier into the list of external identifiers and then triggers the IoT devices corresponding to the external identifiers.

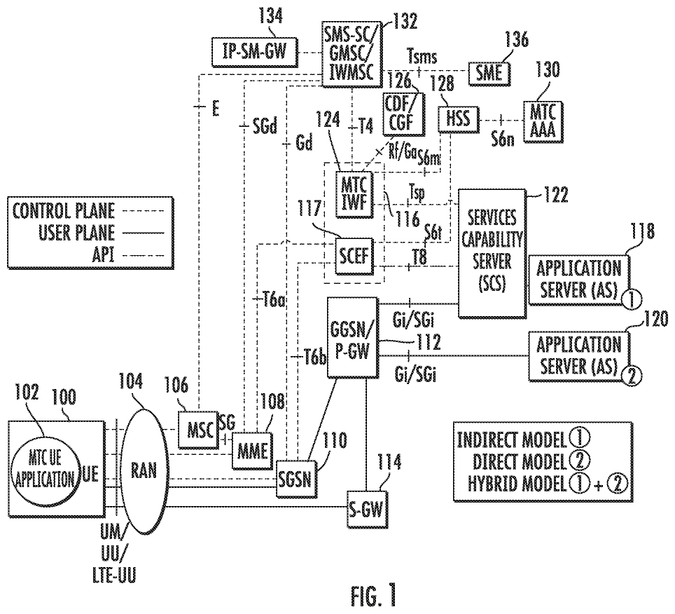

FIG. 1 is a network diagram illustrating an exemplary 3GPP-defined network architecture for triggering IoT devices. The architecture illustrated in FIG. 1 is defined in 3GPP TS 23.682, Technical Specification Group Services and System Aspects; Architecture enhancements to facilitate communications with packet data networks and applications (Release 16), V16.3.0 (2019-06), the disclosure of which is incorporated herein by reference in its entirety. In FIG. 1, the architecture includes user equipment (UEs) 100, which may include machine type communications (MTC) UE applications 102. Thus, UE 100 may be an IoT device, such as a sensor. It may be desirable to trigger plural UEs simultaneously, even when the IP addresses of the UEs are not known to the triggering application. As will be described in detail below, the subject matter described herein includes a mechanism through which an application, such as an application residing on an AS, can initiate group triggering of a selected group of UEs using a single device trigger request message identifying the group of UEs using an external group ID.

UE 100 connects to the core network via radio access network (RAN) 104. RAN 104 may be the evolved universal terrestrial radio access network (E-UTRAN), the new radio (NR) network, or a combination thereof. The node in radio access network 104 that provides radio connectivity to 2G and 3G UE devices is referred to as the base station. For 4G UEs, the node in radio access network 104 that provides radio network connectivity to the UEs is referred to as the evolved node B (ENB). For 5G-capable UEs, the node that provides NR connectivity to the devices is referred to as the gNode B (gNB). RAN 104 is intended to represent one or more base stations, eNBs, and gNBs.

Mobile switching center (MSC) 106 performs mobility management functions for 2G and 3G UE devices. Mobility management entity (MME) 108 performs mobility management functions for 4G capable UE devices. Mobility management functions performed by MSC 106 or MME 108 may include receiving mobile device registrations, communicating mobile subscriber registration and location information to home location register (HLR) or home subscriber service (HSS), and communicating with the nodes in RAN 104 with which UEs are attached to the network.

Serving general packet radio service support node (SGSN) 110 handles packet data communications with mobile users in the network. SGSN 110 functions as the service access point to the GPRS network for the mobile user. On the other side, SGSN 110 communicates with gateway GPRS support node/packet gateway (GGSN/PGW) 112, which can function as the policy enforcement point for packet data communications with mobile users. A policy and charging rules function (PCRF) (not shown in FIG. 1) may perform policy and charging functions for mobile users. The PCRF may include a policy data store that stores policies to be applied to mobile users. The policies may be installed in a policy enforcement point, such as GGSN/PGW 112 to enforce policies for network usage and charging. A signaling gateway (SGW) 114 performs signaling protocol conversions to set up bearer communications with mobile users.

SCEF 116 includes a SCEF function 117 and a machine type communications interworking function (MTC-IWF) 124. SCEF function 117, on the application side, provides an interface for application servers, such as application servers (ASs) 118 and 120 and service capability server (SCS) 122 to communicate with the network. SCEF 116, in one example, is the node that supports group triggering of IoT devices by application servers 118 and 120 and by service capability server 122. In a direct communication model, application servers 118 and 120 may communicate directly with GGSN/PGW 112. In an indirect communication model, application servers 118 and 120 may communicate with the network via SCS 122 and SCEF 116. It should also be noted that application servers 118 and 120 may communicate directly with SCEF 116.

MTC-IWF 124 facilitates communication with IoT devices that do not have IP communications capabilities. A charging data function/charging gateway function (CDF/CGF) 126 generates billing records for network usage. A home subscriber server (HSS) 128 stores subscription and location information for UE devices. In one example, HSS 128 may also be configured with mappings used by SCEF 116 or another node to translate an external group ID into individual IoT device identifiers, such as international mobile subscriber identifiers (IMSIs). A machine type communications authentication authorization and accounting (MTC AAA) server 130 performs AAA functions for MTC devices.

As stated above, IoT devices are triggered using SMS messages. Accordingly, the network architecture may include a short message service center/gateway message service center/interworking message service center (SMSC/GMSC/IWMSC) 132 for generating and delivering SMS messages to IoT devices. An IP short message gateway (IP-SM-GW) 134 may convert IP messages to SMS messages and vice versa. A short message entity (SME) 136 sends and receives SMS messages.

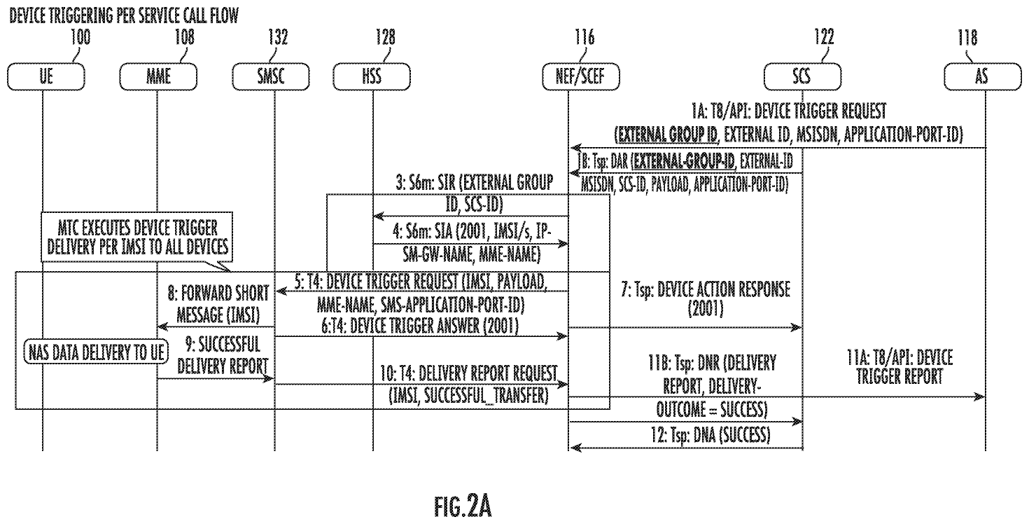

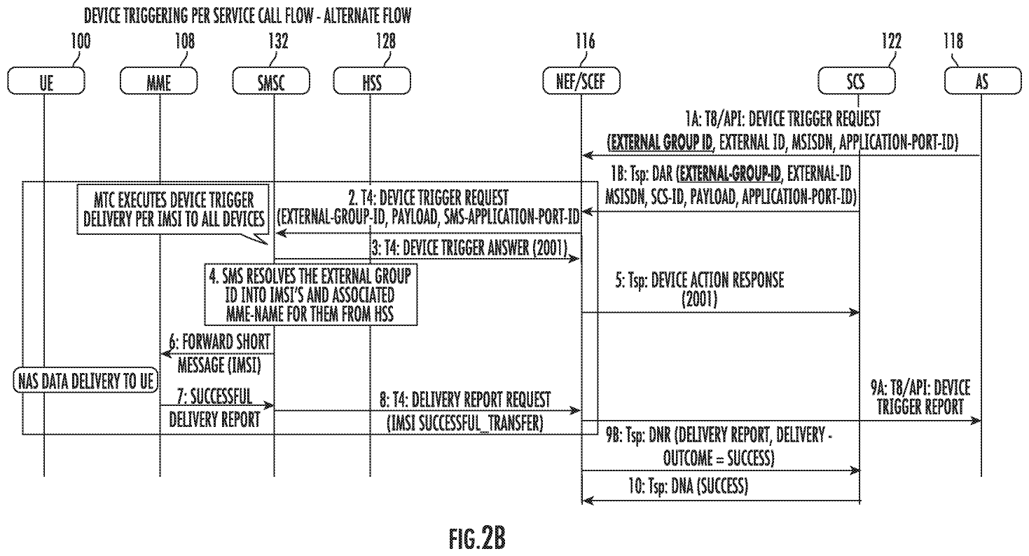

As stated above, in the currently defined 3GPP network architecture, the AS seeking to trigger an IoT device is required to send an individual device trigger message for each target IoT device desired to be triggered. The subject matter described herein avoids the need for the AS to generate trigger messages for each individual IoT device and instead provides for group triggering of IoT devices using a single device trigger message transmitted from the AS to the network. FIG. 2A is a call flow diagram illustrating one example of a call flow for group triggering of IoT devices. Referring to FIG. 2A, in line 1A, AS 118 sends a group device trigger request message to NEF/SCEF 116 via the T8 interface or via an application programming interface (API) published by NEF/SCEF 116. The group device trigger request message includes an external group ID, which identifies the group of IoT devices to which the message is directed. Table 1 shown below illustrates an example of the parameters that may be included in the group device trigger request message.

TABLE 1
Group Device Trigger Request Message

| | | | | |
|---|---|---|---|---|
| | | | | Applicability |
| Attribute Name | Data Type | Cardinality | Description | (Note) |

| | | | |
|---|---|---|---|
| self | Link | 0 . . . 1 | Link to the |
| | | | resource |
| | | | “Individual |
| | | | Device |
| | | | Triggering |
| | | | Transaction”. |
| | | | This |
| | | | parameter |
| | | | shall be |
| | | | supplied by |
| | | | the SCEF in |
| | | | HTTP |
| | | | responses |
| externalId | ExternalId | 0 . . . 1 | Uniquely |
| | | | identifies a |
| | | | user as |
| | | | defined in |
| | | | Clause 4.6.2 |
| | | | of 3GPP TS |
| | | | 23.682 [2] |
| | | | (Note 2) |
| msisdn | Msisdn | 0 . . . 1 | Identifies the |
| | | | MS internal |
| | | | PSTN/ISDN |
| | | | number |
| | | | allocated for |
| | | | a UE (Note 2) |
| externalGroupId | ExternalGroupId | 0 . . . 1 | Identifies a |
| | | | user group |
| | | | as defined in |
| | | | Clause 4.6.3 |
| | | | of 3GPP TS |
| | | | 23.682 [2] |
| | | | (Note 1) |
| supportedFeatures | SupportedFeatures | 0 . . . 1 | Used to |
| | | | negotiate the |
| | | | supported |
| | | | optional |
| | | | features of |
| | | | the API as |
| | | | described |
| | | | above in |
| | | | subclause |
| | | | 5.2.7. This |
| | | | attribute shall |
| | | | be provided |
| | | | in the POST |
| | | | request and |
| | | | in the |
| | | | response of |
| | | | successful |
| | | | resource |
| | | | creation. |
| validityPeriod | DurationSec | 1 | The validity |
| | | | time in |
| | | | seconds for |
| | | | the specific |
| | | | action |
| | | | requested. |
| priority | Priority | 1 | Identifies the |
| | | | priority of the |
| | | | device |
| | | | trigger |
| applicationPortId | Port | 1 | This is used |
| | | | to uniquely |
| | | | identify the |
| | | | triggering |
| | | | application |
| | | | addressed in |
| | | | the device |
| triggerPayload | Bytes | 1 | The device |
| | | | triggering |
| | | | payload |
| notificationDestination | Link | 1 | A URI |
| | | | indicating the |
| | | | notification |
| | | | destination |
| | | | for T8 |
| | | | notifications |
| requestTestNotification | Boolean | 0 . . . 1 | Set to true by |
| | | | SCS/AS to |
| | | | request the |
| | | | SCEF to |
| | | | send a test |
| | | | notification |
| | | | as defined in |
| | | | subclause |
| | | | 5.2.5.3. Set |
| | | | to false or |
| | | | omitted |
| | | | otherwise. |
| websockNotifConfig | WebsockNotifConfig | 0 . . . 1 | Configuration |
| | | | parameters |
| | | | to set up |
| | | | notification |
| | | | delivery over |
| | | | Websocket |
| | | | protocol as |
| | | | defined in |
| | | | subclause |
| | | | 5.2.5.4 |
| deliveryResult | DeliveryResult | 0 . . . 1 | The delivery |
| | | | result shall |
| | | | be included |
| | | | in the HTTP |
| | | | responses |
| | | | that indicate |
| | | | the delivery |
| | | | status of the |
| | | | device |
| | | | triggering |

(Note 1):
Properties marked with a feature as defined in subclause 5.7.4 are applicable as described in subclause 5.2.7. If no features are indicated, the related property applies for all the features.
(Note 2):
One of the properties “externalId” or “msisdn” or “externalGroupId” shall be included.

In Table 1, the group device trigger request message includes 3GPP-defined message parameters specified in Table 5.7.2.1.2 of 3GPP TS 29.122, Technical Specification Group Core Network and Terminals; T8 reference point for Northbound APIs; (Release 16) V16.2.0 (2019-06), the disclosure of which is incorporated herein by reference in its entirety. In addition to the parameters specified in Table 5.7.2.1.2 of 3GPP TS 29.122, Table 1 includes the external group identifier. The external group identifier is defined in clause 4.6.3 of 3GPP TS 23.682. Clause 4.6.3 of 3GPP TS 23.682, however, is not part of the device triggering procedure. According to clause 4.6.3 a subscription for machine type communications may be associated to one or several IMSI group identifiers. A subscription may also be associated to one or several external group identifiers which are stored in the HSS. The external group identifier is formatted the same as the external identifier to find in clause 4.6.2 of 3GPP TS 23.682. According to clause 4.6.2, an external identifier is globally unique and includes a domain identifier, which identifies a domain under the control of the mobile network operator and a local identifier which is used to obtain the IMSI. The local identifier is unique within the applicable domain and is managed by the mobile network operator.

According to clause 4.6.3 of 3GPP TS 23.682, the external group identifier is used on the interface between the SCS/AS and the SCEF and on the interface between the SCEF and the HSS. The identifier is specified for group message delivery, communication pattern provisioning, monitoring event configuration, and monitoring event deletion. However, the external group identifier is not specified for IoT device triggering.

Returning to FIG. 2A, the parameters included in the device trigger request message may include the external group identifier, the external identifier, the MSISDN, and application port ID. It is understood that for group IoT device triggering, the group device trigger request would include the external group identifier instead of the external identifier or the MSISDN. The group device triggering message may also include the additional parameters specified in Table 1 above but only a subset of those parameters are shown in FIG. 2A for illustrative purposes. Allowing the AS to initiate group device triggering using a single device trigger request message identifying the target UEs using the external group identifier reduces the number of messages and the processing by AS 118 to trigger multiple UEs simultaneously.

In an alternate implementation, rather than having the AS initiate the group IoT device triggering, the group IoT device triggering procedure may be initiated by the SCS in line 1B, where the SCS sends a device action request (DAR) message to NEF/SCEF 116 via the Tsp interface. The device action request message is part of the device triggering procedure defined on the TSP interface in 3GPP TS 29.368, Technical Specification Group Core Network and Terminals; Tsp interface protocol between the MTC Interworking Function (MTC-IWF) and Service Capability Server (SCS) (Release 15), V15.0.0 (2018-06), the disclosure of which is incorporated herein by reference in its entirety. According to the device trigger request procedure defined in TS 29.368, to initiate a request for device triggering, the DAR message carries an action type AVP with the value set to device trigger request. The device action request message also includes the MSISDN AVP or external ID AVP, which is set to the identifier of the MTC device being triggered. The device action request also includes the SCS identity AVP, which contains the identity of the SCS that is requesting a device trigger to the UE, a reference number AVP that contains a reference number that the SCS assigns to the trigger request, a trigger data AVP containing data to be sent to the MTC device. The trigger data includes the priority of the trigger and the identity of the triggering application in the device. The device action request also includes a validity time period.

In addition to the 3GPP-defined triggering parameters, the device action request also includes an external group identifier, which identifies the group of IoT devices to which the device action request message is directed. The external group identifier is not part of the device triggering procedure defined in 3GPP TS 29.368 for the Tsp interface. By allowing the SCS to identify a group of IoT devices being triggered in a single device action request message, the subject matter described herein reduces the signaling required for an SCS to simultaneously trigger plural IoT devices. In the example illustrated in FIG. 2A, the device action request includes one of: the external group ID, the external ID, and the MSISDN. The device action request also includes the SCS ID, the payload, and the application port ID. Specific parameters in the payload are not illustrated for simplicity.

In line 2 of the message flow diagram, NEF/SCEF 116 resolves the external group ID into a list of external identifiers corresponding to the individual UEs that will receive the message. In line 3 of the message flow diagram, NEF/SCEF 116 sends an S6m subscription information request (SIR) message to HSS 128 to obtain the IMSIs, the IP short message gateway name, and the MME name of the IP short message gateway and the MME serving the UEs. In line 4, HSS 128 responds with a subscription information answer (SIA) the IMSIs, the short message gateway name, and the MME name. The S6m procedures for obtaining subscriber information from the HSS are described in 3GPP TS 29.336, Technical Specification Group Core Network and Terminals; Home Subscriber Server (HSS) diameter interfaces for interworking with packet data networks and applications (Release 15), V15.6.0 (2019-03), the disclosure of which is incorporated herein by reference in its entirety. According to 3GPP TS 29.336, the SIR message is a command sent from the MTC-IWF to the HSS or from the MTC-AAA to the HSS. The SIR command shall include a user identifier AVP, which contains one of the following identifiers that are used to identify a UE. The following is the AVP definition for user identifier specified in 3GPP TS 29.336:

User identifier::=<AVPheader:3102 10415>
[user-name]
[MSISDN]
[external-identifier]
[LMSI]
*[AVP]

Instead of using an identifier that identifies a single UE, NEF/SCEF 116 may include the external group identifier in the user identifier AVP to identify a group of UEs for HSS 128 to resolve into individual IMSIs. The subscriber information answer command also includes the user identifier AVP. Instead of carrying a single user identifier, the subscriber information answer command may carry the list of IMSIs resolved by HSS 128 from the external group identifier. The subscriber information answer command also includes a T4 data AVP that contains the names of the serving nodes, i.e., the MSC or MME, SGSN, or IP-SM-GW.

In line 5, NEF/SCEF 116 sends a device trigger request to SMSC 132 on the T4 interface. The T4 interface is defined in 3GPP TS 29.337, Technical Specification Group Core Network and Terminals; Diameter-based T4 interface for communications with packet data network and applications (Release 15), V15.0.0 (2018-06), the disclosure of which is incorporated herein by reference in its entirety. According to 3GPP TS 29.337, the device trigger request message or command includes a user identifier AVP, a serving node AVP, a trigger action AVP, as well other parameters or AVPs used to support triggering of an IoT device. In FIG. 2A, the device trigger request includes the IMSI, the triggering payload, the MME name, and the SMS application port ID. It is understood that additional parameters, such as those described in 3GPP TS 29.337 may be included in the device trigger request message. The device trigger request message in line 6 may be repeated for each IMSI of each IoT device being triggered. In line 6, SMSC 132 responds with a device trigger answer message. In line 7, NEF/SCEF 116 sends a device action response to SCS 122 on the T8 interface. The device action response message is sent to SCS 122 if SCS 122 initiated the group IoT device triggering procedure. If SCS 122 did not initiate the group IoT device triggering procedure, the device action response message in line 7 may be omitted.

In line 8, SMSC 132 sends, for each IMSI, a forward short message (FSM) message containing the device trigger request for each IMSI. The forward short message is a mobile application part (MAP) message used to deliver short messages to mobile devices. MAP protocol specification is defined in 3GPP TS 29.002, Technical Specification Group Core Network and Terminals; Mobile Application Part (MAP) specification (Release 15) V15.5.0, (2019-06), the disclosure of which is incorporated herein by reference in its entirety. The forward short message message may be formatted according to the MT-forward-SM message format specified in 3GPP TS 29.002. The forward short message message is sent to the MME 108, which sends the message to the UE. The message is delivered to the UE using downlink non-access stratum (NAS) transport procedures defined in 3GPP TS 36.413, Technical Specification Group Radio Access Network’ Evolved Universal Terrestrial Radio Access Network (E-UTRAN); S1 Application Protocol (S1AP) (Release 15), V15.6.0 (2019-07), the disclosure of which is incorporated herein by reference in its entirety. According to 3GPP TS 36.413, the MME sends a downlink NAS transport message to eNB including the NAS message as a NAS PDU information element. The message is sent transparently to the eNB. In this example, the NAS PDU will include the message for triggering the UE. The eNB delivers the NAS PDU to the UE over the air interface.

If delivery of the SMS trigger request is successful, in line 9, MME 108 responds with a successful delivery report. In line 10, SMSC 132 sends a delivery report answer message to indicating successful transfer of the SMS message for the given IMSI. In line 11A, NEF/SCEF 116 sends a T8 device trigger report to AS 118. The device trigger report message in line 11A is sent to AS 118 if AS 118 initiated the group device triggering using the group device trigger request message in line 1A of the call flow diagram. If, instead, the group device triggering was initiated by SCS 122, NEF/SCEF 116 will send a device notification request (DNR) delivery report message to SCS 122 via the Tsp interface, indicating successful delivery of the device trigger request. In line 14, SCS 122 sends an answer to the delivery report to NEF/SCEF 116.

In FIG. 2A, NEF/SCEF 116 resolves the external group ID into IMSIs using HSS 128. In an alternate implementation, SMSC 132 resolves the external group ID into IMSIs and associated MME name. FIG. 2B illustrates this call flow. Referring to FIG. 2B, as in FIG. 2A, the group device triggering may be initiated by AS 118 or SCS 122. In line 1A, AS 118 initiates the group device triggering by sending a device trigger request message to NEF/SCEF 116 via the T8 interface. The group device trigger message includes the external group ID identifying the desired group of UEs. In the second option, as illustrated by line 1B, SCS 122 initiates the group device triggering by sending a DAR message to NEF/SCEF 116 via the Tsp interface. The DAR message includes the external group identifier that identifies the target UEs to which the group device trigger request is directed.

In this example, NEF/SCEF 116 does not resolve the external group ID into the IMSIs of the individual UEs. Instead, in line 2, NEF/SCEF 116 sends a T4 device trigger request message to SMSC 132. The T4 trigger request includes the external group ID. In line 3, SMSC 132 sends a device trigger answer message to NEF/SCEF 116 confirming that the device trigger request has been successfully processed.

In line 4 of the message flow diagram, SMSC 132 resolves the external group identifier into IMSIs and associated MME names by querying HSS 128. In particular, SMSC 132 queries HSS 128 using the external group identifier. HSS 128 access its subscriber database using the external group identifier and resolves the external group identifier into a list of IMSIs and corresponding serving MME names. HSS 128 responds to SMSC 132 with a list of IMSIs and MME names corresponding to the external group identifier.

In line 5, NEF/SCEF 116 sends a device action response on the Tsp interface to SCS 122. The message in line 5 will be sent if the SCS 122 initiated the group device triggering. Otherwise, the message in line 5 would not be sent.

In line 6, SMSC 132 sends, for each IMSI corresponding to the external group identifier, a forward short message (FSM) message including the device trigger request to the serving MME. MME 108 receives the FSM message and forwards the message to the eNB or gNB serving the UE using the NAS data delivery procedures described above. The eNB or gNB then delivers the device trigger request message to the UE.

In line 7, MME 108 responds to SMSC 132 indicating a successful delivery of the group device trigger request. In line 8, SMSC 132 sends a T4 delivery report request to NEF/SCEF 116 indicating successful delivery of the trigger request message to a UE. In step 9A, if AS 118 initiated the group device triggering, NEF/SCEF 116 responds to AS 118 with a device trigger report indicating successful delivery of the device trigger request message. In step 9B, if SCS 122 initiated the group device triggering, NEF/SCEF 116 sends a delivery report message on the Tsp interface to SCS 122 indicating successful delivery of the group device trigger request. In line 10, SCS 122 responds to NEF/SCEF 116 indicating successful delivery of the group device triggering message. It should be noted that the messaging in lines 6-8 of FIG. 2B will be repeated for each UE corresponding to an IMSI mapped to the external group ID. However, it should also be noted that AS 118 or SCS 122 is only required to send a single message to NEF/SCEF 116 to initiate the group device triggering. It should also be noted that AS 118 and SCS 122 are not required to know the IMSIs or IP addresses of the individual UEs that map to the external group ID.

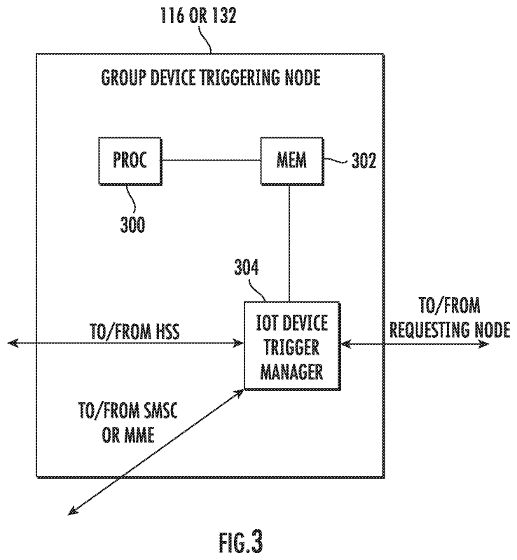

FIG. 3 is a block diagram of a group device triggering node for implementing group IoT device triggering as described herein. Referring to FIG. 3, group device triggering node may be an NEF/SCEF that uses the call flow illustrated in FIG. 2A or an SMSC that utilizes the call flow illustrated in FIG. 2B. Group device triggering node is therefore labeled with reference numbers 116 or 132, respectively corresponding to SCEF/NEF 116 or SMSC 132. In FIG. 3, group device triggering node 116 or 132 includes at least one processor 300 and a memory 302. Group device triggering node 116 or 132 further includes a group IoT device trigger manager 304 that manages group triggering of IoT devices. For example, group IoT device trigger manager 304, in the case where group device triggering node is an NEF/SCEF may receive a message requesting group device triggering from an SCS or an AS. Group IoT device trigger manager 304 may be configured to determine whether the device trigger message contains an identifier for a group of IoT devices. In response to determining that the IoT device triggering message includes a group identifier for triggering a group of IoT devices, IoT device trigger manager 304 may query HSS 122 to resolve the group device identifier into a list of IMSIs for the individual UEs to be contacted. Continuing with the example where the group device triggering node is NEF/SCEF 116, IoT device trigger manager 304 may forward the list of IMSIs and the device triggering content to the SMSC for delivery to the individual IoT devices.

For the case where the group device triggering node is an SMSC, IoT device trigger manager 304 may be configured to receive a T4 device trigger request from NEF/SCEF 116. In response, group device triggering node 116 or 132 may obtain a list of IMSIs corresponding to the external group ID on HSS 128. HSS 128 may be configured by the network operator with mappings between external group identifiers and IMSIs. For example, the network operator may provision in HSS 128 a mapping between an external group identifier and a list of IMSIs assigned to IoT devices of the same type. In another example, the network operator may provision HSS with a mapping between an external group identifier and a geographic location. When IoT devices register attach to the network in the geographic location, their IMSIs may become associated with the external group identifier. Group device triggering node 116 or 132 may forward individual forward short message messages to each IMSI that maps to the external group identifier in the group device trigger request message.

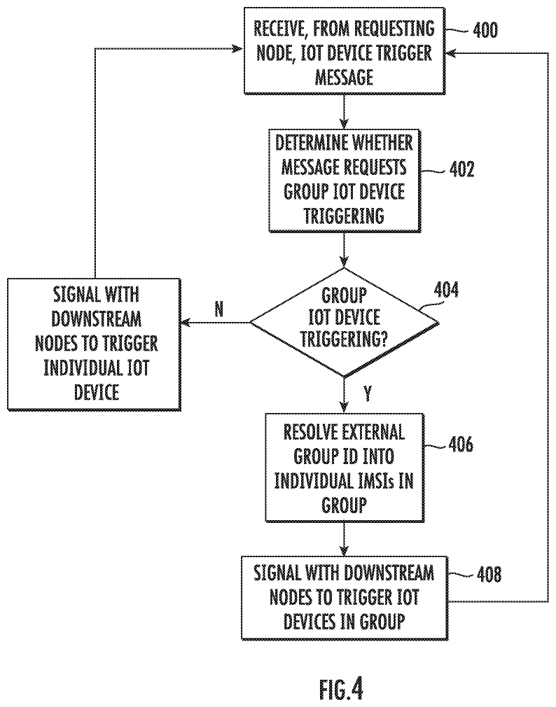

FIG. 4 is a flow chart illustrating an exemplary process for group triggering of IoT devices. Referring to FIG. 4, in step 400, an IoT device trigger message is received from a requesting node. For example, in the call flow in FIG. 2A, the IoT device trigger message may be received at NEF/SCEF 116 either from SCS 122 or from AS 118. In an alternate implementation where the SMSC resolves the external group ID into a list of IMSIs, SMSC 132 may receive a device trigger request message from an NEF/SCEF 116.

In step 402, it is determined whether the message requests group IoT device triggering. This step may be performed by parsing a message to determine whether it is a device trigger request message and whether the device trigger request message includes an external group ID.

In step 404, if the message is determined to require group IoT device triggering, control proceeds to step 406 where the external group ID is resolved into individual IMSIs in the group. In the option illustrated in FIG. 2A, NEF/SCEF 116 resolves the external group ID into individual IMSIs by querying HSS 128 using the external group ID and receiving a list of IMSIs. In the option illustrated in FIG. 2B, SMSC 132 resolves the external group ID into individual IMSIs by querying HSS 128 using the external group identifier and receiving the list of IMSIs from the HSS.

In step 408, the network node performing the group device triggering signals with downstream nodes to trigger IoT devices in the group. In the example illustrated in FIG. 2A, NEF/SCEF 116 signals with SMSC 132, which initiates delivery of SMS messages to each IMSI identified in the list. SMSC 132 forwards SMS messages including the device trigger requests to each identified UE. In the option illustrated in FIG. 2B, SMSC 132 sends the SMS messages to the UEs corresponding to the IMSIs.

Accordingly, using the processes described herein, an SCS or AS can initiate group triggering of IoT devices using a single message including an external group ID. An advantage of such an approach is that the SCS or AS is not required to know, at the time of initiating group IoT device triggering, the individual IMSIs of IoT devices that are being triggered. All the SCS or AS is required to know at the time of initiating the group IoT device triggering is he external group identifier. The network operator can control which IoT devices can be triggered using the external group identifier by maintaining the appropriate mappings in the HSS.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. A method for group device triggering for Internet of things (IoT) devices, the method comprising:
receiving, from a requesting node, a device trigger request message;
determining that the device trigger request message requests group IoT device triggering;
in response to determining that the device trigger request message requests group IoT device triggering, resolving an external group identifier in the device trigger request message to individual international mobile station identifiers (IMSIs) corresponding to target IoT devices of the device trigger request message; and
signaling a downstream node to trigger the target IoT devices.

2. The method of claim 1 wherein the requesting node comprises an application server (AS) and wherein receiving the device trigger request message includes receiving a single device trigger request message from the AS including the external group identifier for triggering the target IoT devices.

3. The method of claim 1 wherein the requesting node comprises a service capability server (SCS) and the device trigger request message comprises a single device trigger request message including the external group identifier for triggering the target IoT devices.

4. The method of claim 1 wherein the external group identifier is associated with a group of IoT devices of the same type.

5. The method of claim 1 wherein the external group identifier is associated with a group of IoT devices in the same geographic area.

6. The method of claim 1 wherein receiving the device trigger request message includes receiving the device trigger message at a network exposure function/service capability exposure function (NEF/SCEF) and wherein resolving the external group identifier into the IMSIs includes querying, by the NEF/SCEF, a home subscriber server (HSS) using the external group identifier.

7. The method of claim 6 wherein querying the HSS using the external group identifier includes sending a subscriber information request (SIR) command to the HSS and including the external group identifier in an attribute value pair of the SIR command.

8. The method of claim 6 wherein signaling a downstream node to trigger the IoT devices in the group includes sending, from the NEF/SCEF, for each of the IMSIs, a device trigger request message to a short message service center (SMSC).

9. The method of claim 1 wherein receiving the device trigger request message includes receiving the device trigger request message at a short message service center (SMSC) and wherein resolving the external group identifier into the IMSIs includes querying, by the SMSC a home subscriber server (HSS) using the external group identifier.

10. The method of claim 8 wherein signaling a downstream node includes sending, for each of the IMSIs, a forward short message message from the SMSC to a mobility management entity (MME) serving an IoT device corresponding to the IMSI.

11. A system for group triggering of Internet for things (IoT) devices, the system comprising:
a group IoT device triggering node including at least one processor; and
an IoT device triggering manager implemented by the at least one processor for receiving, from a requesting node, a device trigger request message, determining that the device trigger request message requests group IoT device triggering, and, in response to determining that the device trigger request message requests group IoT device triggering, resolving an external group identifier in the device trigger request message to individual international mobile station identifiers (IMSIs) corresponding to target IoT devices of the device trigger request message, and signaling a downstream node to trigger the target IoT devices.

12. The system of claim 11 wherein the requesting node comprises an application server (AS) and wherein the IoT device triggering manager is configured to receive a single device trigger request message from the AS including the external group identifier for triggering the target IoT devices.

13. The system of claim 11 wherein the requesting node comprises a service capability server (SCS) and wherein the IoT device triggering manager is configured to receive a single device trigger request message including the external group identifier for triggering the target IoT devices.

14. The system of claim 11 wherein the external group identifier is associated with a group of IoT devices of the same type.

15. The system of claim 11 wherein the external group identifier is associated with a group of IoT devices in the same geographic area.

16. The system of claim 11 wherein the group IoT device triggering node comprises a network exposure function/service capability exposure function (NEF/SCEF) and wherein resolving the external group identifier into the IMSIs includes querying, by the NEF/SCEF, a home subscriber server (HSS) using the external group identifier.

17. The system of claim 16 wherein the IoT device trigger manager is configured to send, from the NEF/SCEF, for each of the IMSIs, a device trigger request message to a short message service center (SMSC).

18. The system of claim 16 wherein the group IoT device triggering node comprises a short message service center (SMSC) and wherein resolving the external group identifier into the IMSIs includes querying, by the SMSC a home subscriber server (HSS) using the external group identifier.

19. The system of claim 8 wherein the IoT device trigger manager is configured to send, for each of the IMSIs, a forward short message (FSM) message from the SMSC to a mobility management entity (MME) serving an IoT device corresponding to the IMSI.

20. A non-transitory computer readable medium having stored thereon executable instructions that when executed by a processor of a computer control the computer to perform steps comprising:
receiving, from a requesting node, a device trigger request message;
determining that the device trigger request message requests group Internet of things (IoT) device triggering;
in response to determining that the device trigger request message requests group IoT device triggering, resolving an external group identifier in the device trigger request message to individual international mobile station identifiers (IMSIs) corresponding to target IoT devices of the device trigger request message; and
signaling a downstream node to trigger the target IoT devices.
